(19) United States
(12) Patent Application Publication
(10) Pub. No.: US 2020/0156161 A1
(43) Pub. Date: May 21, 2020

(54) DEVICE FOR REMOVING AN INSTALLED FASTENER IN AN OPENING

(71) Applicant: LISI AEROSPACE, Paris (FR)

(72) Inventor: ADRIEN LE ROY, Parthenay (FR)

(73) Assignee: LISI AEROSPACE, Paris (FR)

(21) Appl. No.: 16/689,053

(22) Filed: Nov. 19, 2019

(30) Foreign Application Priority Data
Nov. 20, 2018 (FR) 1871605

(51) Int. Cl. B23B 47/28; B23B 51/00

(52) U.S. Cl. CPC B23B 47/284; B23B 2247/12; B23B 51/0054

(57) ABSTRACT

The present invention concerns a device for removing a fastener (12) installed in the hole of a structure, said device comprising:
a base (20) capable of being fastened to the structure, and
a guiding device, defining a cylindrical passage (78) and including:
   a support (48) equipped with a first removable assembly means with the base in a first assembled configuration;
   a blocking element (50), mobile relative to the support; and
   a device (83, 84) for adjusting an axial position of the blocking element relative to the support, to a blocked configuration corresponding to the engagement of said blocking element with the fastener (12), so as to prevent the rotation of said fastener relative to the structure.

The present invention concerns a device for removing fasteners installed in the hole of a structure.

The invention applies in particular to the removal of what are referred to as blind fasteners, or rivets. Blind fasteners are fasteners installed through structures via a single face of said structures, commonly referred to as the “accessible face” or “operational face”.

These fasteners are used in particular for the assembly of aircraft structures in which the other face, called the “blind face”, is inaccessible to the operator. Fasteners of this type are, for example, described in document FR3016417.

It is sometimes necessary to remove rivets or other blind fasteners, either for maintenance purposes or because the fastener has been improperly installed. The removal of such fasteners usually involves destroying the head of said fastener, which then enables the remaining part to be pushed out of the hole on the opposite side of the accessible face. It is generally common practice to remove fasteners by drilling the head with a drill bit or drill tool, as described in document U.S. Pat. No. 7,555,820.

However, it is important to avoid damaging the edges of the hole in the structure when destroying the head of the fastener; this makes it a delicate operation. For this purpose, the rotation of the fastener by the rotary tool used to drill the fastener head must be prevented. Document U.S. Pat. No. 7,555,820 describes notably the assembly of a blocking part for the drilling tool with suitable cavities, fitted in the fastener assembly.

The purpose of the present invention is to propose a device for the effective and secure removal of a fastener, without requiring any modification to the shape of said fastener.

The object of the invention, therefore, is a removal device of the type described above, comprising: a base with a removable attaching device to the structure; and a guiding device, forming a cylindrical passage positioned along a first axis, said cylindrical passage being able to accommodate a drill bit for drilling the fastener. The said guiding device comprises: a support with a first removable assembly means to be joined to the base in a first assembled configuration; a blocking element, movable relative to the support along the first axis; and an adjusting device for adjusting the axial position of the blocking element relative to the support, between a blocked configuration and an unblocked configuration, the said blocked configuration corresponding to an engagement of a distal end of the blocking element with the fastener, thus preventing the rotation of said fastener relative to the structure.

Among other beneficial aspects of the invention, the removal device includes one or more of the following feature(s), taken individually or in accordance with all possible technical combinations:

the distal end of the blocking element includes blocking parts that prevent the rotation of the fastener relative to the structure, said blocking parts having sharpened edges, capable of embedding into the fastener through pressure along the first axis;

the blocking parts are positioned in a substantially circular manner around the cylindrical passage;

the adjusting device comprises: a compression spring, capable of moving the blocking element axially in the opposite direction to the distal end; and a stop capable of preventing said movement, said stop comprising an assembly means configured to be assembled to the support with an adjustable axial position;

the securing device of the base includes at least one suction pad;

the removal device also includes a drill bit capable of axially drilling through the cylindrical passage of the guiding device;

the removal device also comprises a positioning device with a viewing opening along a second axis, said positioning device being equipped with a second removable assembly means to the base in a second assembled configuration, said second removable assembly means being configured so that, relative to the base, the second axis in the second assembled configuration is substantially identical to the first axis in the first assembled configuration;

the removal device also comprises a lighting fixture capable of sending a light beam into the viewing opening.

The invention also relates to a removal process of a fastener installed in a hole of a structure by means of a removal device as described above, said hole opening on to the operational face of said structure, said fastening being substantially positioned along a third axis and comprising a substantially cylindrical shank and a head forming a radial projection relative to the shank; said procedure comprising the following steps: fastening the base to the operational face of the structure; and assembly of said base with the guiding device, so that the first and third axes are substantially identical; adjustment of the axial position of the guiding device blocking element in the blocked configuration, so as to prevent the fastener head rotating relative to the operational face; and perforation of the fastener head by means of a drill bit guided by the cylindrical passage of the guiding device.

Among other beneficial aspects of the invention, the removal process includes one or more of the following feature(s), taken individually or in accordance with all possible technical combinations:

the fastener comprises: a sleeve with a substantially cylindrical body and a collar forming a radial projection relative to the body; and a bolt with a substantially cylindrical shank and a head forming a radial projection relative to the shank; the bolt shank being positioned in the body of the sleeve, the collar of the sleeve being engaged with the operational face of the structure; the procedure comprising the following steps: adjustment of the axial position of the blocking element of the guiding device in the blocked configuration, in such a way as to prevent the rotation of sleeve collar relative to the operational face; and perforation of the bolt head using a perforating drill bit guided by the cylindrical passage of the guiding device;

the step for fastening the base to the operational face includes: the removable assembly of the positioning device to the base in the second assembled configuration, then the displacement of the base relative to the operational face into an operational position, where the bolt head and/or sleeve collar are substantially centered relative to the viewing opening, then the installation of the removable assembly device, so as to secure the base to the operational face, then the disconnection of the base and the positioning device.

### BRIEF DESCRIPTION OF THE DRAWINGS

The invention will be better understood after reading the following description, which is provided solely as a non-limiting example, and with reference to the drawings, where:

FIG. 1 is an exploded view of elements from the removal device according to one embodiment mode of the invention;

FIG. 2 is a perspective view of another element of the removal device in FIG. 1;

FIGS. 3 to 5 are sectional views of steps in the procedure for the removal of a fastener using the device in FIGS. 1 and 2;

FIG. 6 is a detailed view of FIG. 5; and

FIG. 7 is a sectional view of another step in the above-mentioned removal procedure.

### DETAILED DESCRIPTION

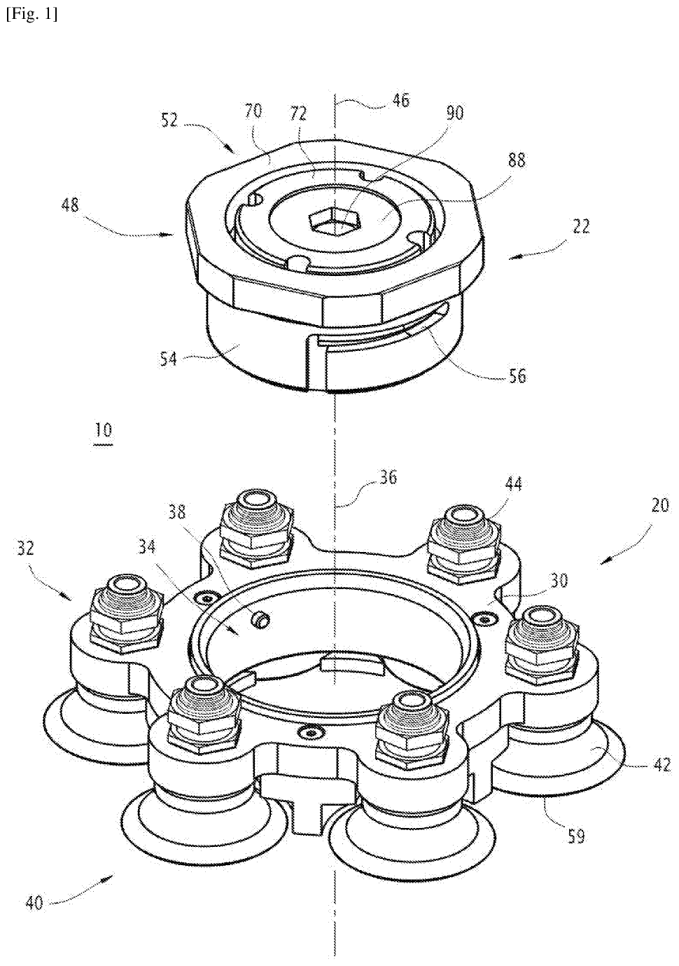

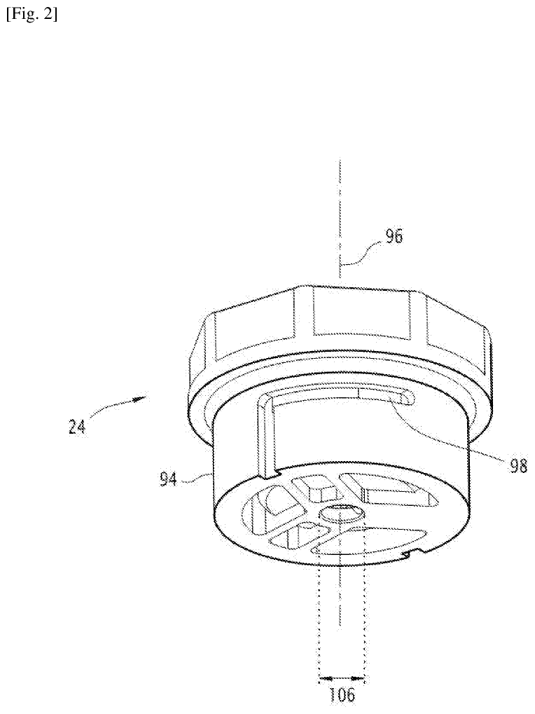

FIGS. 1 and 2 show views of elements of the removal device 10 according to one embodiment mode of the invention.

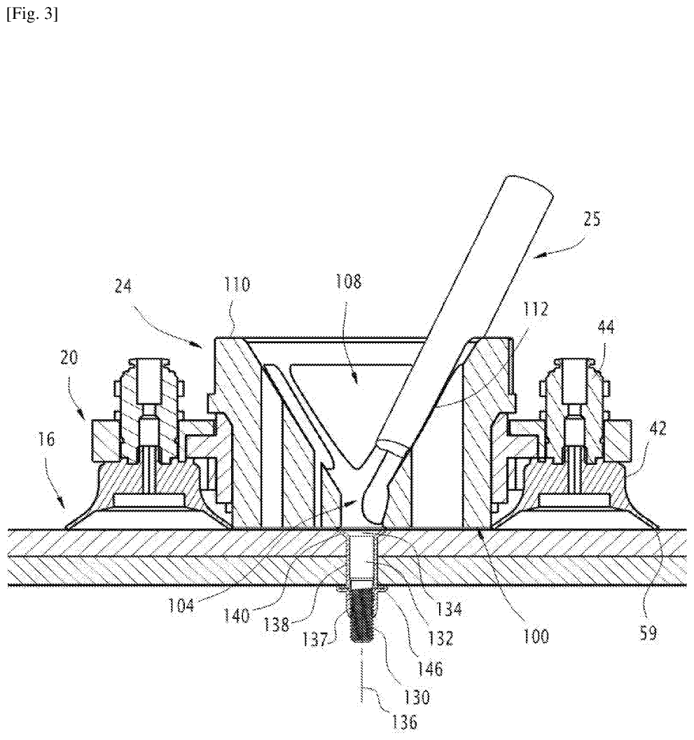

The removal device 10 is specifically intended for the removal of a fastener 12 installed in the hole 14 of a structure 16, as shown in FIGS. 3 to 7. Fastener 12 and structure 16 will be described in greater detail hereinafter.

The removal device 10 includes specifically a base 20 and a guiding device 22, shown alone in FIG. 1. In addition, the removal device 10 is preferably fitted with a positioning device 24, shown in FIGS. 2 and 3, and a lighting fixture 25.

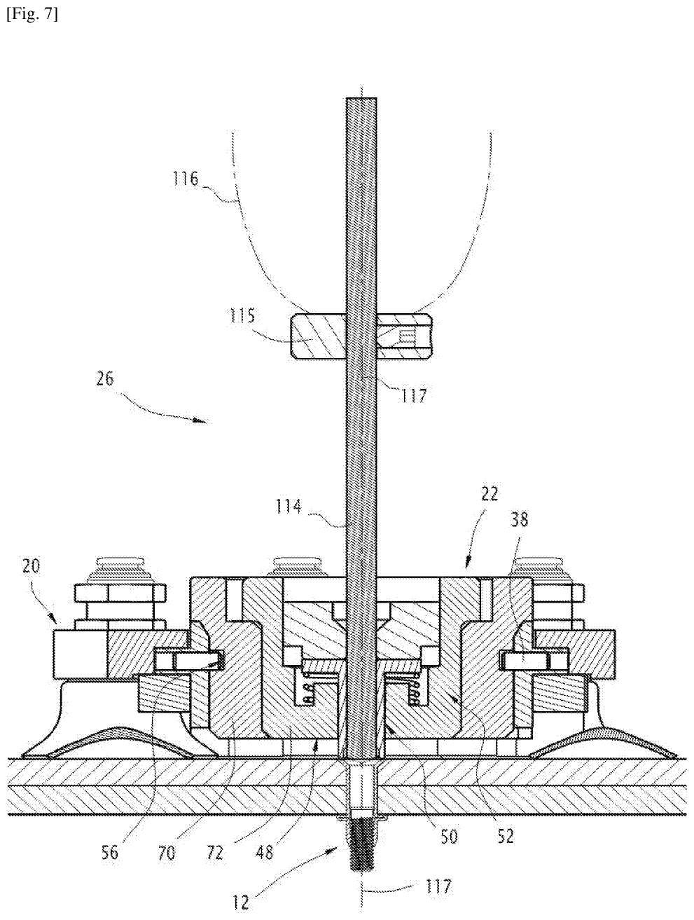

Optionally, the removal device 10 may also include a perforation tool 26, shown in FIG. 7.

The base 20 has an annular body 30 and includes an attachment device 32. The annular body 30 is defined as a substantially cylindrical cavity 34, extending along an axis 36 and open at both ends. One of the cavity walls 34 includes assembly elements 38 such as pins that form an internal projection towards the axis 36.

The attachment device 32 is intended to temporarily secure the base 20 to a flat surface substantially perpendicular to the axis 36. As described hereinafter, the attachment device 32 is specifically intended to temporarily secure the base 20 to one of the faces of the structure 16.

In the embodiment mode shown, the attachment device 32 comprises a plurality of suction pads 40 assembled to the annular body 30 around the cavity 34. The suction pads 40 are positioned evenly in a circle centered on axis 36. Each suction pad 40 includes a flexible skirt 42 topped with an air intake 44.

The guiding device 22 is substantially positioned along an axis 46 and comprises a support 48, a blocking element 50 and an adjusting device 52 for adjusting the axial position of the blocking element relative to the support.

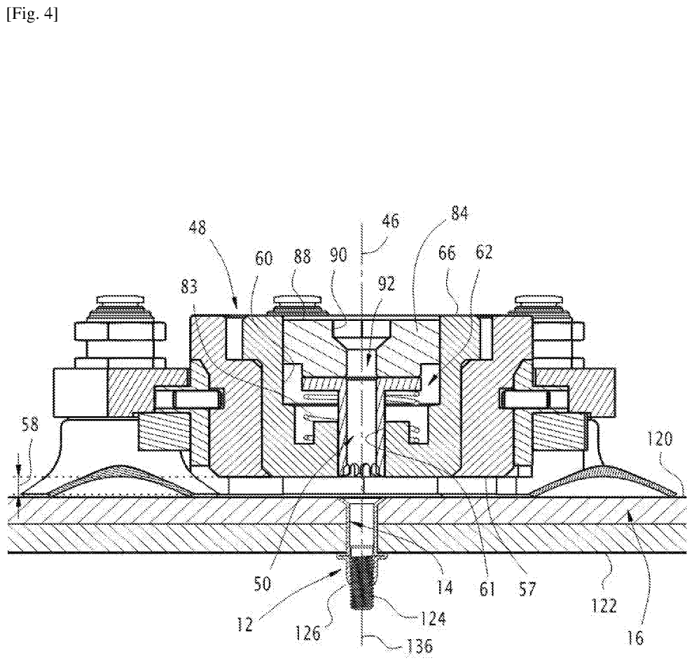

The support 48 comprises a first substantially cylindrical outer surface 54 around the axis 46, the said first outer surface substantially matching the inner cavity 34 of the base 20. The said first outer surface 54 comprises the first means 56 of removable assembly and the assembly elements 38 of the said base, in a first assembled configuration shown in FIGS. 4 to 7.

Preferably, the said first assembly means 56 are capable of blocking the support 48 relative to the base 20, in axial translation and in rotation in at least one direction. The first assembly means 56 are for example L-grooves, each groove allowing a bayonet type assembly with a pin 38 from the base.

In the first assembled configuration, the axis 36 of the annular body 30 and the axis 46 of the guiding device 22 are identical. In addition, in this first assembled configuration, a so-called distal end 57 of the support 48, facing the flexible skirts 42 of the suction pads 40 of the base 20, is set back from a distance 58 relative to a plane formed by the edges 59 of said flexible skirts 42.

The support 48 also comprises an inner wall 60 of a substantially rotational shape around the axis 46, defining an internal space 61, 62.

The internal space consists of a distal portion 61 and a proximal portion 62, adjacent along the axis 46 and in communication with each other. Both the distal 61 and proximal 62 portions open onto one of the ends of the support 48, that is, on the distal end 57 and on the opposite end, or proximal end 66, respectively.

The distal portion 61 of the internal space has a substantially constant first diameter. The proximal portion 62 has a second diameter that is greater than the first diameter. At the said proximal portion 62, the inner wall 60 of the support 48 comprises an internal thread 68. The said internal thread 68 preferably has a low pitch, notably less than 3 mm.

In the embodiment mode shown, the support 48 consists of an external element 70 and an internal element 72 coaxial and interlocked together. The external element 70 comprises the first outer surface 54 and the internal element 72 comprises the inner wall 60.

The blocking element 50 has a tubular body 74 and an annular crown 76, secured to the proximal end of said tubular body. The tubular body is capable of sliding axially into the distal portion 61 of the internal space of the support 48. The annular crown 76 is positioned in the proximal portion 62 of said internal space and has a diameter greater than that of the distal portion 61.

The tubular body 74 is open at both axial ends, forming a cylindrical passage 78. A distal end of the said tubular body includes blocking parts 80 to prevent rotation, positioned substantially evenly around said cylindrical passage 78. The blocking parts 80 have a sharpened shape, able to embed axially into a material, as it will be detailed hereinafter.

In the embodiment mode shown, the blocking parts that prevent rotation are shaped as teeth 80, with a sharpened edge 81 to each of said teeth. The said sharpened edges are substantially positioned along a circle diameter 82.

The adjusting device 52 comprises a compression spring 83 and an adjusting stud 84.

The compression spring 83 enters into the proximal portion 62 of the internal space of the support 48. A distal end of said spring is fixed relative to the support 48. The proximal end of said spring is in axial abutment with the annular crown 76 of the blocking element 50. The compression spring 83 tends to move the blocking element 50 axially towards the proximal end 66 of the support 48.

In the embodiment mode shown, the compression spring 83 is a helical spring. In an unrepresented variant, the compression spring is, for example, formed by Belleville washers.

The adjusting stud 84 is positioned in the proximal portion 62 of the internal space of the support 48 and has an external thread 86 capable of cooperating with the internal thread 68 of said support. A distal face of the adjusting stud 84 is in axial abutment with the annular crown 76 of the blocking element 50, opposite to the compression spring 83. A proximal face 88 of the adjusting stud 84 has a recess 90 allowing to drive said stud in rotation in the support 48. The recess 90 has for example a hexagonal shape, capable of cooperating with an Allen key.

The adjusting stud 84 also comprises a through-hole 92 positioned along the axis 46 and extending the recess 90 to the distal face of said stud.

The adjusting stud 84 is suitable for being screwed or unscrewed in the support 48 using an Allen key type tool that cooperates with the recess 90. An axial position of the adjusting stud relative to the support can thus be adjusted by an operator.

In particular, FIG. 4 shows the guiding device 22 in a first so-called unblocked configuration. The proximal face 88 of the adjusting stud 84 is substantially coplanar with the proximal end 66 of the support 48. The spring 83 is in a first state of compression and the tapered edges 81 of the teeth 80 of the blocking element 50 are substantially coplanar with the distal end 57 of the support 48.

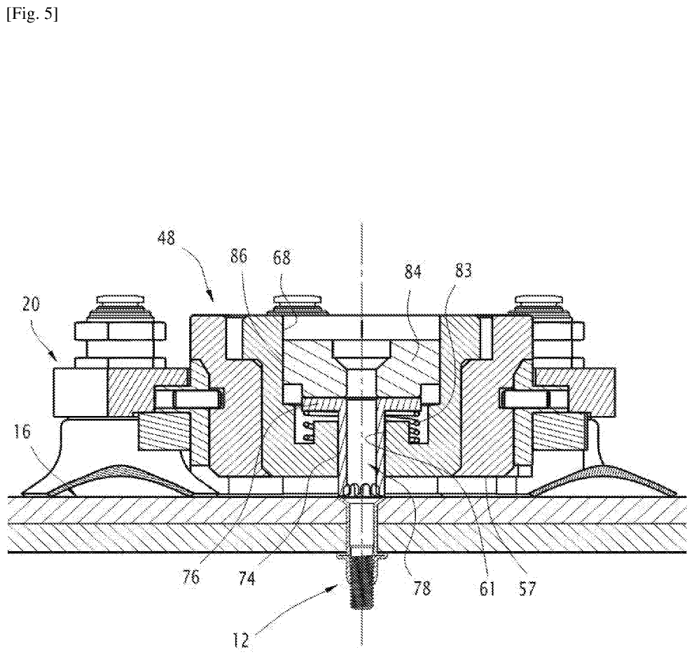

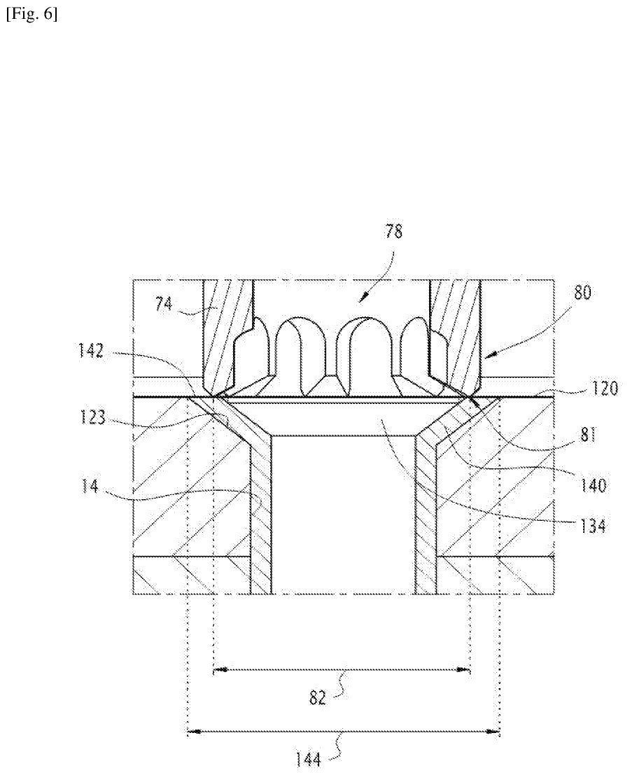

In addition, FIGS. 5 and 6 represent the guiding device 22 in a second so-called blocked configuration. The proximal face 88 of the adjusting stud 84 is located inside the proximal portion 62 of the internal space. The spring 83 is in a second state of compression, more compressed than the first state mentioned above. The sharpened edges 81 of the teeth 80 of the blocking element 50 form a projection relative to the distal end 57 of the support 48. The blocked configuration will be discussed in more detail hereinafter.

The positioning device 24, shown in FIGS. 2 and 3, comprises a second, substantially cylindrical outer surface 94 around an axis 96. The said second outer surface 94 has a substantially matching shape to that of the inner cavity 34 of the base 20. The said second outer surface 94 comprises the second means 98 of removable assembly with the assembly elements 38 of said base, in a second assembled configuration shown in FIG. 3. In said second assembled configuration, the axis 36 of the annular body 30 and the axis 94 of the guiding device 24 are identical.

As with the first assembly means 56 of the guiding device 22, the second assembly means 98 are, for example, L-grooves allowing a bayonet type assembly.

The positioning device 24 is configured so that in the second assembly configuration, a distal face 100 of said positioning device is substantially coplanar with the edges 59 of the flexible skirts 42 of the suction pads 40 of the base 20.

The positioning device 24 has a viewing opening 104, of cylindrical shape centered on the axis 96 and opening on to the distal face 100. The said opening 104 comprises a diameter 106.

In addition, the positioning device 24 preferentially comprises a conical cavity 108 which extends the viewing opening 104 flaring up to a proximal face 110 of said positioning device 24.

In the embodiment mode shown, the conical cavity comprises a channel 112 extending substantially along a cone generator. The channel 112 is suitable for insertion of the lighting fixture 25, which presents itself as a lamp with an elongated shape. Inserted into the channel 112, the lamp 25 sends a light beam through the viewing opening 104 in the direction of the distal face 100. In an unrepresented variant, the conical cavity includes several channels.

The drill tool 26 comprises a drill bit 114, a stop 115 and a rotary drill tool 116.

The drill bit 114, has a substantially cylindrical shape along an axis 117, and is capable of sliding into the cylindrical passage 78 of the blocking element 50 and into the through-hole 92 of the adjusting stud 84.

The stop 115, for example, has the shape of a washer positioned around the drill bit to limit its axial movement in said cylindrical passage 78.

The removal device 10 described above is intended for the removal of the fastener 12, shown in FIGS. 3 to 7, which will now be described.

The fastener 12 is installed in the hole 14 of a structure 16, for example, an aircraft structure panel. The structure 16 consists of, for example, composite material elements.

The structure 16 comprises notably of a first 120 and second 122 opposing faces, the first face 120 referred to as the “accessible face” or “operational face” and the second face 122 referred to as the “blind face”.

The hole 14 passes through the structure 16 from the first face 120 to the second 122 face. The hole 14 is essentially cylindrical in shape. In the proximity of the first face 120, the hole also comprises a countersink 123.

In this example, the fastener 12 is a blind fastener and includes a bolt 124 and a sleeve 126, inserted into the hole 14. The bolt 124 and the sleeve 126 are metallic consisting of, for example, type A286 stainless steel or titanium alloy.

The bolt 124 comprises a threaded portion 130, a shank 132 and a head 134, aligned along an axis 136. In the embodiment mode shown, the head 134 is a countersunk head, flush with the first face 120 of the structure 16 in the installed configuration of FIGS. 3 to 7.

The sleeve 126 has a tubular shape and comprises a threaded portion 137, a smooth body 138 and a flared collar 140, aligned along the axis 136. The collar 140 is positioned in the flared end 123 of the hole 14. A free end 142 of the said collar substantially has the shape of a flat ring, with notably an outer diameter 144.

In the installed configuration, the collar 140 receives the head 134 of the bolt 124, one end of said head and the free end 142 of said collar being substantially coplanar with the first face 120 of the structure 16.

According to an unrepresented variant, the collar of the sleeve is substantially flat and in abutment against the first face 120; and the bolt head protrudes relative to said first face.

According to an unrepresented variant, the fastener 12 is a rivet comprising a shank and a flattened head on each face of the structure.

The shank 132 of the bolt is inserted in the body 138 of the sleeve on the interior of the hole 14. The threaded portion 130 of the bolt and the threaded portion 137 of the sleeve, screwed together, form a projection relative to the second face 122 of the 16 structure.

In the installed configuration, the sleeve body comprises an outer bulge 146 engaged with the said second face 122. This type of installation of the fastener 12 in a structure 16 with the formation of an outer bulge is described in particular in document FR3016417.

The blocking element 50 and the positioning device 24 of the removal device 10 are configured in accordance with the dimensions of the fastener 12.

In particular, the diameter 82 of the circle formed by the teeth 80 of the blocking element is less than the outer diameter 144 of the free end of the fastener 12 collar 140, and greater than the outer diameter of the screw head 134. The blocking element 50 is preferably configured so that the sharpened edges 81 of all the teeth 80 engage simultaneously with said collar 140.

According to an embodiment mode not shown, the removal device 10 comprises several blocking elements similar to the blocking element 50 described above, but with different diameters 82.

According to an embodiment mode not shown, the diameter 82 of the circle formed by the teeth 80 of the blocking element is less than the outer diameter of the flattened head of the rivet to be removed.

Similarly, the diameter 106 of the viewing opening 104 of the positioning device 24 is preferentially equal to the outer diameter 144 of the free end of the fastener 12 collar 140.

To good purpose, the drilling tool 26 of the removal device 10 is also configured according to the dimensions of the fastener 12. The diameter of the drill bit 114 is, in particular, larger than the diameter of the bolt 124 shank 132 and smaller than the diameter of the hole 14.

A removal procedure of the fastener 12 with the device 10 described above will now be described.

Firstly, the base 20 and positioning device 24 are assembled together in the second assembled configuration of FIG. 3. Then, the distal face 100 of the said positioning device and the edges 59 of the suction pad 40 skirts 42 of the said base are placed against the first face 120 of the structure 16, close to the fastener 12.

The base 20/positioning device 24 assembly is then moved by sliding against the first face 120 to an operational position, where the head 134 of the bolt and/or the collar 140 of the sleeve are substantially centered relative to the viewing opening 104. In the said operational position, shown in FIGS. 3 to 7, the axis 36 of the annular body 30 of base 20 and the axis 136 of the fastener 12 are substantially identical.

Where the said opening has a diameter 106 substantially equal to the outer diameter 144 of the collar 140, the operational position is easily identified by the operator because the collar 140 is part of the viewing opening 104. The lighting fixture 25 is used to facilitate the determination of the operational position visually, by illuminating the bolt head 134 and the collar 140 of the sleeve.

The base 20 is then held in the operational position while depressurization is carried out in the skirts 42 of the suction pads 40, through air suction at the air intakes 44. The suction pads 40, therefore, firmly secure the base 20 to the first face 120 of the structure in said operational position.

The positioning device 24 is then separated from the base 20. The guiding device 22, in the unblocked configuration of FIG. 4, is assembled in said base according to the first assembled configuration. The axis 46 of said guiding device 22 and the axis 136 of the fastener 12 are then substantially identical.

Using an Allen key, the adjusting stud 84 is screwed into the proximal portion 62 of the internal space of the support 48. The said stud then moves towards the first face 120 of the structure 16, pulling the blocking element 50 and compressing the spring 83. The teeth 80 of the blocking element 50 then move axially at a distance equivalent to the set-back distance 58, until they engage with the free end 142 of the sleeve 126 collar 140.

The tightening of the adjusting stud 84 is continued so as to exert an axial pressure on the blocking element 50 in the direction of the sleeve 126. The blocked configuration, shown in FIGS. 5 and 6, is then reached. In this blocked configuration, as shown in FIG. 6, the sharpened edges 81 of the teeth 80 of the blocking element 50 are embedded into the free end 142 of the collar 140. The sleeve 126 is thus held rotationally fixed relative to the structure 16 by the base 20/guiding element 22 assembly.

The fine pitch of the internal thread 68 and the external thread 86 allows the precise adjustment of the axial position of the adjusting stud 84 relative to the support 48 in the blocked configuration, so as to adjust the axial pressure exerted on the sleeve 126 by the blocking element 50. The position of the adjusting stud 84 is maintained by the opposite axial pressure exerted by the spring 83 on the annular crown 76 of the blocking element.

The sleeve 126 is held in a fixed position relative to the structure 16, and the head 134 of the bolt 124 is perforated with the drill bit 114 of the drill tool 26. The contact of the drill bit 114 with the head 134 is guided by the through-hole 92 and the cylindrical passage 78 of the guiding device, into which the drill bit is inserted.

The drill bit 114 is thus driven into the head 134 while being rotated by the tool 116. The diameter of the drill bit is larger than that of the shank 132 making it possible to destroy said head 134 and to disassociate the collar 140 of the smooth body 138 of the sleeve.

The sleeve 126 being rotationally fixed avoids any friction between said sleeve and the edges of the hole 14. Similarly, the stop 115, engages with the proximal end 66 of the support 48, and prevents the drill bit from embedding too deeply into the screw 124 and/or the hole 14. This reduces the risk of damaging the hole 14 during the use of the drill bit 114.

The drill bit 114 is then removed from the guiding device 22 and the fastener 12 is then pushed axially into the hole 14, to be ejected from the said hole by the second face 122 of the structure 16. The flared collar 140 of the sleeve, separated from the smooth body 138 during the perforation of the fastener, is detached from the countersink 123 through the first face 120 of the structure.

In an alternative variant, the diameter of the drill bit is less than that of the bolt 124 shank 132. In this case, a second tool is required to separate the flared collar 140 from the smooth body 138 of the sleeve.

Finally, the air intakes 44 of the base 20 are open, so as to separate said base 20 from the structure 16.

Whatever the method of removal used, a new permanent fastener can then be installed in the hole 14 which is now empty.

1. Device for removing a fastener installed in a hole of a structure, said device comprising:
a base with a removable attachment device to the structure; and
a guiding device, forming a cylindrical passage positioned along a first axis, said cylindrical passage being capable of receiving a drill bit for perforating the fastener, the said guiding device comprising:
a support equipped with a first means for the removable assembly to the base in a first assembled configuration;
a blocking element, movable relative to the support along the first axis; and
an adjusting device for adjusting the axial position of the blocking element relative to the support, between a blocked configuration and an unblocked configuration, said blocked configuration corresponding to an engagement of a distal end of said blocking element with the fastener, so as to prevent the rotation of the fastener relative to the structure.

2. The removal device according to claim 1, in which the distal end of the blocking element includes blocking parts that rotationally fix the fastener relative to the structure, said blocking parts having a sharpened edge, capable of embedding into the fastener through pressure along the first axis.

3. The removal device according to claim 2, in which the blocking parts are substantially positioned along a circle diameter around the cylindrical passage.

4. Removal device according to claim 1, in which the adjusting device comprises: a compression spring, capable of axially moving the blocking element in a direction opposite to the distal end; and a stop capable of preventing said movement, said stop comprising an assembly means for assembly to the support along an adjustable axial position.

5. The removal device according to claim 1, where the removable attachment device includes at least one suction pad.

6. Removal device according to claim 1, comprising further a drill bit capable of axially passing through the cylindrical passage of the guiding device.

7. Removal device according to claim 1, comprising further a positioning device with a viewing opening positioned along a second axis, said positioning device being fitted with a second assembly means of assembly to the base in a second assembled configuration, said second removable assembly means being configured so that, relative to the base, the second axis in the second assembled configuration is substantially identical to the first axis in the first assembled configuration.

8. Removal device according to claim 7, comprising further a lighting fixture capable of sending a light beam into the viewing opening.

9. Process for removing a fastener installed in the hole of a structure by means of a removal device according to claim 1, said hole opening on to an operational face of said structure, said fastener being substantially positioned along a third axis and comprising a substantially cylindrical shank and a head forming a radial projection relative to the shank;
said process comprising the following steps:
fastening the base to the operational face of the structure; and assembling said base with the guiding device, so that the first and third axes are substantially identical;
adjusting an axial position of the blocking element of the guiding device in the blocked configuration, so as to prevent the rotation of the head of the fastener relative to the operational face; and
drilling the fastener head using a drill bit guided by the cylindrical passage of the guiding device

10. Removal process according to claim 9, where the fastener comprises:
a sleeve comprising a substantially cylindrical body and a collar forming a radial projection relative to the body; and
a bolt comprising a substantially cylindrical shank and a head forming a radial projection relative to the shank;
the shank of the bolt being positioned in the body of the sleeve, the collar being engaged with the operational face of the structure;
said process comprising the following steps:
adjusting an axial position of the blocking element of the guiding device in the blocked configuration, so as to prevent the rotation of the collar of the sleeve relative to the operational face; and
drilling the bolt head using a drill bit guided by the cylindrical passage of the guiding device.

11. Removal process for removing a fastener installed in a hole of a structure by means of a removal device, the removal device comprising:
a base with a removable attachment device to the structure; and
a guiding device, forming a cylindrical passage positioned along a first axis, said cylindrical passage being capable of receiving a drill bit for perforating the fastener, the said guiding device comprising:
a support equipped with a first means for the removable assembly to the base in a first assembled configuration;
a blocking element, movable relative to the support along the first axis; and
an adjusting device for adjusting the axial position of the blocking element relative to the support, between a blocked configuration and an unblocked configuration, said blocked configuration corresponding to an engagement of a distal end of said blocking element with the fastener, so as to prevent the rotation of the fastener relative to the structure,
said hole opening on to an operational face of said structure, said fastener being substantially positioned along a third axis and comprising a substantially cylindrical shank and a head forming a radial projection relative to the shank;
said process comprising the following steps:
fastening the base to the operational face of the structure; and assembling said base with the guiding device, so that the first and third axes are substantially identical;
adjusting an axial position of the blocking element of the guiding device in the blocked configuration, so as to prevent the rotation of the head of the fastener relative to the operational face; and
drilling the fastener head using a drill bit guided by the cylindrical passage of the guiding device
in combination with claim 7, where the attachment procedure of the base to the operational face comprises:
removably assembling the positioning device with the base in the second assembled configuration, and
moving the base relative to the operational face to an operational position, where the bolt head and/or the collar of the sleeve are substantially centered relative to the viewing opening, and
activating the removable attachment device, so as to secure the base to the operational face, and
disconnecting the base and the positioning device.
